(19) United States
(12) Patent Application Publication
(10) Pub. No.: US 2005/0255996 A1
(43) Pub. Date: Nov. 17, 2005

(54) Thermosensitive recording medium and manufacturing method thereof

(76) Inventors: Toshiyuki Tamura, Shizuoka (JP); Takayuki Hiyoshi, Shizuoka (JP); Chiaki Tanuma, Tokyo (JP)

Correspondence Address: DLA PIPER RUDNICK GRAY CARY US LLP, P. O. BOX 9271, RESTON, VA, 20195, US

(21) Appl. No.: 11/123,164

(22) Filed: May 6, 2005

(30) Foreign Application Priority Data
May 13, 2004 (JP) P2004-143892

(51) Int. Cl. B41M 5/30

(52) U.S. Cl. 503/204

(57) ABSTRACT

There is provided a thermosensitive recording medium in which a first thermosensitive coloring layer that develops a first hue and a second thermosensitive coloring layer that develops a second hue different from the first hue, wherein the first and second thermosensitive coloring layers having the respective widths are continuously formed in stripes in a longitudinal direction of a substrate. There is also described a method of manufacturing a number of the thermosensitive recording mediums from a substrate in that, after a multiplicity of the thermosensitive coloring layers are formed by repetitively coating a plurality of water-dispersion thermosensitive inks on the substrate having an ink receptive layer thereon, the respective inks having different coloring hues, the substrate is slit into multiple thermosensitive recording mediums along a line or lines provided over any of the thermosensitive coloring layer or layers.

### CROSS REFERENCE TO RELATED APPLICATION

This application is based upon and claims the benefit of priority from the prior Japanese Patent Application No. 2004-143892 filed on May 13, 2004, the contents of which are incorporated herein by reference.

### FIELD OF THE INVENTION

The present invention relates generally to a thermosensitive recording medium and a method of manufacturing a thermosensitive recording medium, particularly to a method of manufacturing of a high-quality multicolor thermosensitive recording medium that develops a plurality of colors.

### DESCRIPTION OF THE BACKGROUND

Conventionally, there has been proposed a method of recording multicolor images by divisionally forming thermosensitive coloring layers that develop more than one color on a substrate and selectively applying heat to pixels developing a desired color.

For example, in Japanese patent application Kokai publication No. 60-208283, a multicolor thermosensitive recording medium is described in which a plurality of thermosensitive coloring materials developing different colors are divisionally coated on a recording surface of a substrate and images of different colors are formed in the respective regions where thermosensitive coloring materials of different colors are coated.

In Japanese patent application Kokai publication No. 2000-301835, there is described another multicolor thermosensitive recording medium that divisionally develops different colors. This recording medium comprises a support, dye layers containing leuco dyes developing different coloring hues that are formed and arranged in parallel on a substrate without one layer overlapping another, and a developer layer or layers containing a developer formed adjacent to, above or/and beneath the dye layers. This dye layers are formed in stripes by sequentially coating each ink of different colors by means of a printing process (screen printing, gravure printing, and offset printing). By narrowing widths of the respective dye layers and miniaturizing a heat-applying part of a thermal recording head, high-resolution full-color images can be formed.

However, the inventors of the present invention have found that thermosensitive coloring layers and thermosensitive recording mediums that are formed using a printing process involve several problems.

Method of forming plural thermosensitive coloring layers on a thermosensitive recording medium using a printing process is suitable for producing labels having thermosensitive coloring layers of the same form as shown in FIG. 17 or the same size. However, it is difficult to produce labels having different lengths from the formed medium.

Second problem lies during formation of thermosensitive coloring layers. As typical thermosensitive ink for producing a thermosensitive recording medium, water-dispersion thermosensitive ink is widely used, in which pigment components comprising an electron-accepting compound, for example, a developer, an electron-donating compound, for example, a leuco dye, a sensitizer, etc. are dispersed in water using a dispersant such as a surfactant.

By coating this water-dispersion thermosensitive ink using a coating apparatus such as a blade coater, air knife coater, roll coater, bar coater, gravure coater, and lip coater, a film having a uniform thickness can be formed on a substrate.

However, when a thermosensitive coloring layer is formed by coating water-dispersion thermosensitive ink by a printing process that uses a printing plate such as a relief printing plate, engrave plate, and stencil printing plate, thickness of the printed film needs to be largely increased to obtain a fair optical density comparing to a normal printing process for producing literatures using printing ink. The inventors of the present invention confirmed that, when such a thermosensitive recording medium on which water-dispersion thermosensitive ink is thickly coated is heated in an oven or others to dry the medium, a striped pattern is developed. This striped pattern is a phenomenon, called “streaking or streaks,” which emerges as a state of ‘waving’ failing for the water-dispersion thermosensitive ink to spread smoothly over the surface of the medium when a printing plate is separated from a substrate during a printing process. This phenomenon is considered to likely occur to water-dispersion thermosensitive ink containing a pigment relating to own characteristics of this ink.

When an image is formed on a thermosensitive recording medium that forms thermosensitive coloring layers having such a phenomenon by applying heat energy to the medium by a thermal print head, a region corresponding to such a striped pattern appears as an image having an irregular density.

If an organic-solvent based thermosensitive ink that is formulated using an organic solvent in which a leuco dye and developer are dispersed is used in stead of such water-dispersion thermosensitive ink, a striped pattern as in FIG. 18 hardly appears, because the organic-solvent based thermosensitive ink that is coated holds an excellent liquid-levelling characteristic comparing to the water-dispersion thermosensitive ink. However, since an organic solvent readily dissolves substances like a developer and leuco dye used as constituents in thermosensitive ink, fogging (herein, it refers to adverse light color development by an organic solvent that likely occurs in a process of forming thermosensitive coloring layer) tends to occur on a medium surface. To alleviate this fogging, the kinds of usable leuco dyes and developers need to be limited. This narrows down a selectable range in kinds of materials that develop various colors, making it difficult to realize colorization. Accordingly, an organic-solvent based thermosensitive ink increases manufacturing costs.

In view of the above problems, the inventors of the present invention proposed a method of forming a thermosensitive recording medium in Japanese patent application Kokai publication No. 2003-99356 (corresponding U.S. patent application Ser. No. 10/854,413), in which the phenomenon of “streaking” can be alleviated to a practically trouble-free degree by impregnating water-dispersion thermosensitive ink into a substrate and providing an ink receptive layer holding a film thickness that secures a predetermined recording density and lowering a surface tension of water-dispersion thermosensitive ink so as to enhance penetrability into a substrate and leveling characteristic of the ink.

If penetrability and leveling characteristic of water-dispersion thermosensitive ink are boosted, color mixing between thermosensitive coloring layers of different colors adjacent to each other tends to occur. Particularly in engraved printing, the ink makes it hard to remove excess ink with a doctor blade because the water-based inks generally increase friction of a doctor blade comparing to solvent-base inks. Accordingly, water-dispersion thermosensitive inks makes a doctor blade to wear easily, and color mixing between inks adjacent thermosensitive coloring layers of different colors tends to occur owing to boosting of its penetrability and levelling characteristic of the inks in effort to alleviate “streaking.”

### SUMMARY OF THE INVENTION

According to one aspect of the present invention, there is provided a thermosensitive recording medium that comprises a substrate in a roll, at least a first thermosensitive coloring layer developing a first hue and a second thermosensitive coloring layer developing a second hue different from the first hue, wherein the first and second thermosensitive coloring layers are formed in parallel continuously in a longitudinal direction of the thermosensitive recording medium, the thermosensitive coloring layers of different hues having the respective widths.

According to another aspect of the present invention, there is provided a method of manufacturing a thermosensitive recording medium that comprises a step of preparing a substrate in a roll, a step of preparing a first printing plate for forming a first thermosensitive coloring layer developing a first hue, the first thermosensitive coloring layer continuously extending in a longitudinal direction of the substrate and having a width, a step of preparing a second printing plate for forming a second thermosensitive coloring layer developing a second hue different from the first hue, the second thermosensitive coloring layer continuously extending in a longitudinal direction of the substrate and having a width, a step of ink-coating using the first and second printing plates to form the first and second thermosensitive coloring layers such that the first and second thermosensitive coloring layers are arranged in parallel extending in a longitudinal direction of the substrate, a step of dividing for dividing the thermosensitive recording medium including the first and second thermosensitive coloring layers by cutting the second thermosensitive coloring layer that is formed in the step of ink-coating in a longitudinal direction.

By this structure, there can be provided a recording medium whose length can be flexibly changed and which does not hold “streaking,” which likely occur in a thermosensitive recording medium having a thermosensitive coloring layer formed through a printing process that uses a printing plate. In addition, color mixing that tends to occur on a process of forming thermosensitive coloring layers of different colors on a thermosensitive recording medium can be prevented.

### BRIEF DESCRIPTION OF THE DRAWINGS

FIG. 1 is a plan view of a thermosensitive recording medium according to one embodiment of the present invention.

FIG. 2 is a sectional view of the thermosensitive recording medium shown in FIG. 1.

FIG. 3 is an example of recoding on the thermosensitive recording medium.

FIG. 4 is a schematic diagram of a roll of a thermosensitive recording medium.

FIG. 5 is a schematic diagram illustrating a process of producing a roll of the thermosensitive recording medium according to the present invention.

FIG. 6 is a schematic diagram of a printing plate that is used for producing a roll of the thermosensitive recording medium according to the present invention.

FIG. 7 is a plan view of the thermosensitive recording medium according to the present invention.

FIG. 8A displays, as a comparative example, cutting a thermosensitive recording medium on regions of the medium other than thermosensitive coloring layers, and

FIG. 8B displays an example of cutting the medium over thermosensitive coloring layers.

FIG. 9 displays a perspective view and side view of a thermosensitive recording medium of an alternative example in a folded form according to the present invention.

FIG. 10 is a plan view of a thermosensitive recording medium according to a first embodiment of the present invention.

FIG. 11 is a plan view of a thermosensitive recording medium according to a second embodiment of the present invention.

FIG. 12 is a plan view of a thermosensitive recording medium according to a third embodiment of the present invention.

FIG. 13 is a plan view of a thermosensitive recording medium according to a fourth embodiment of the present invention.

FIG. 14 is a plan view of a thermosensitive recording medium as a first comparative example.

FIG. 15 is a plan view of a thermosensitive recording medium as a second comparative example.

FIG. 16 is a plan view of a thermosensitive recording medium as a fifth comparative example.

FIG. 17 is a plan view of a conventional multi-color thermosensitive recording medium.

### DETAILED DESCRIPTION OF THE INVENTION

Preferred embodiments of the present invention will now be described in more detail with reference to the accompanying drawings. The same numerals are applied to the similar elements in the drawings, and therefore, the detailed descriptions thereof are not repeated.

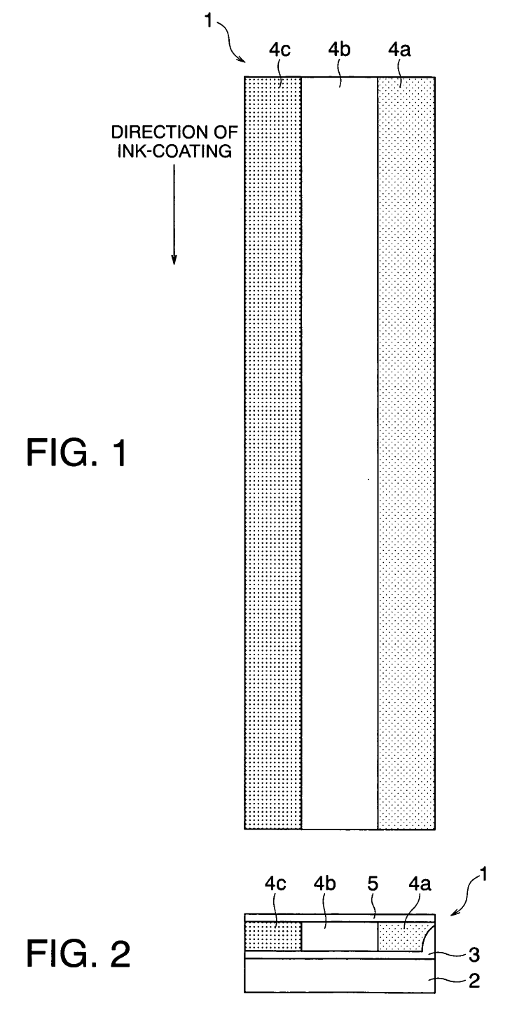

An embodiment according to the present invention will be described in reference to FIGS. 1 though 3.

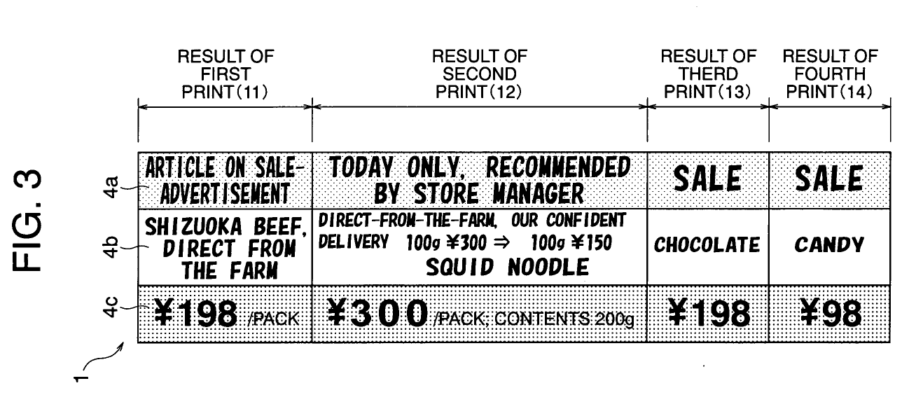

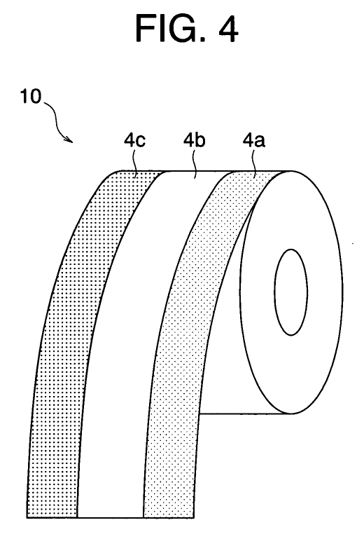

FIG. 1 is a plan view of a thermosensitive recording medium. FIG. 2 is a cross sectional view of the thermosensitive recording medium shown in FIG. 1. FIG. 3 is a plan view displaying a state of printing.

In this thermosensitive recording medium 1, there are formed a substrate 2, an ink receptive layer 3 formed on a surface of substrate 2, thermosensitive coloring layers 4a, 4b, and 4c developing different coloring hues that are formed over ink receptive layer 3, and a protective layer 5 that is provided as needed.

Thermosensitive coloring layers 4a, 4b, and 4c having different coloring hues are formed in parallel stripes in a longitudinal direction of the substrate using a printing process, each stripe having a prescribed width. “Longitudinal direction” means a direction of feeding of a continuous paper that is used as substrate 2 during a printing process. This direction conforms to a direction of printing characters in a printer. Substrate 2 is a base material on which thermosensitive coloring layers are formed by coating ink thereon on an ink-coating process and which is divided into several thermosensitive recording mediums being cut in its longitudinal direction.

Thermosensitive coloring layers 4a, 4b, and 4c need to be formed in stripes continuously in the ink-coating direction. Printing process that meets this need of performance is gravure printing.

Using gravure printing, thermosensitive coloring layers 4a, 4b, and 4c are formed integrally with ink receptive layer 3 by making ink penetrate into receptive layer 3, as illustrated in FIG. 2. Generally, when a thermosensitive coloring layer is formed using a printing process, “streaking” likely occurs. However, this occurrence of “streaking” can be controlled by forming thermosensitive coloring layers integrally with ink receptive layer 3 making the former layer penetrate into the latter. “Integral forming of the thermosensitive coloring layers with ink receptive layer 3” means that thermosensitive coloring layers 4a, 4b, and 4c totally penetrate ink receptive layer 3 after the inks are coated and dried. In this case, some of the ink may remain on a surface of ink receptive layer 3 without deeply penetrating the ink receptive layer as long as “streaking” does not affect recording quality when printing is performed.

Thermosensitive recording medium 1 formed in continuous stripes can be used, for example, as shown in FIG. 3, as a point of purchase advertisement (POP ad) such as a price card. In the POP ad, for example, articles of the advertisement and highlighted characters of “SALES” can be recorded on e thermosensitive coloring layer 4a in blue, descriptions and bar-codes of the articles can be recorded on thermosensitive coloring layer 4b in black, and prices of the articles can be recorded on thermosensitive coloring layer 4c in red, so that the ad can produce a well effect visually to attract customers to the articles.

Because thermosensitive coloring layers 4a, 4b, and 4c are provided in continuous stripes, thermosensitive recording medium 1 can flexibly be used by cutting the medium at a desired length according to a length of recording characters, as shown in FIG. 3. Although thermosensitive recording medium 1 in FIGS. 1 though 3 show only part of thermosensitive recording medium roll 10, thermosensitive coloring layers 4a, 4b, and 4c are continuously formed in stripes.

As for a combination of thermosensitive coloring layers formed in stripes, thermosensitive coloring layers 4a that develops blue (a third color hue), thermosensitive coloring layers 4b that develops black (a second color hue), thermosensitive coloring layers 4b that develops red (a first color hue) are favored. In this color combination, red thermosensitive coloring layers 4c expresses emphasis and therefore is often used for recording important information. To make it more visually effective, the width of this red layer is better to be formed wider than other layers. First, second, third color hues referred herein denote merely different colors and are not restricted to particular colors.

As for the widths of thermosensitive coloring layers 4 formed in stripes, if they are too narrow, a visual effect of emphasis by different colors becomes diminished. Desirable width may be some 10 mm, considering the accuracy of recording positioning in a printer. Particularly, considering recording of a bar-code that is required in black or blue thermosensitive coloring layers 4, some 10 mm is mostly required. (According to the JAN requirements relating to a bar-code, the height of a bar-code must be 18.29 mm in terms of 0.8 times minimum magnification. Actually, since a bar-code at a height of a half of this height can be readily read by a bar-code scanner, a height of more than 10 mm is preferable.)

Since a multi-color thermosensitive recording medium 1 is mostly used in cases where images or characters need to be visually distinguished, a balance in the respective color hues becomes important. Therefore, the width of stripes of each of the thermosensitive coloring layers is preferably more than one tens of the width of the thermosensitive recording medium. Also, even more preferably, providing generally equal widths in the respective layers makes the images visually more effective.

As materials suitable for substrate 2, there are, for example, paper, plastic film such as of polyethylene terephthalate, metallic foil, etc. However, they are not limited to the above, as long as they do not prevent the object of the present invention.

Ink receptive layer 3 needs to be absorptive for water-dispersion thermosensitive ink to prevent “streaking” on thermosensitive coloring layers 4 that are formed using a printing process, and comprises a pigment as a main component and a binder resin. Pigments usable for this layer include, for example, an inorganic pigment, such as clay, calcined clay, calcium carbonate, titanium oxide, alumina, aluminum hydroxide, silica; organic pigments of beaded hollow resins, such as styrenes, styrene-acrylics, acrylics. Also preferable for use is a porous pigment, which is formed by flocculation of a mass of its primary particles, for example, a calcium carbonate or synthetic silica.

Binder resins usable for ink receptive layer 3 include water-soluble macromolecules and water-soluble macromolecule emulsions. The water-soluble macromolecules include, for example, polyvinyl alcohol, starch and its derivatives, cellulosic derivatives, gelatine, casein, styrene-dihydrogen maleic copolymer salt, styrene-acrylic acid copolymer salt. The water-soluble macromolecule emulsions include emulsions of latex of styrene-butadiene copolymer, vinyl acetate resin, styrene-acrylic ester copolymer, and polyurethane resin, etc. As needed, a lubricant such as zinc stearate, wax, and an additive such as hindered phenols may be added to ink receptive layer 3.

Ink for receptive layer 3 is formulated such that, first, a coating liquid is prepared by dispersing and mixing in water a hydrophilic pigment, binder resin, and some additives if need. As needed, other additive of a pigment dispersant such as sodium polyacrylate, sodium hexamethacrylate, denatured sulfonic polyvinyl alcohol, etc., a defoamer, ultraviolet absorbent, and antiseptic, etc. may be added to the liquid.

Ink receptive layer 3 is formed by coating a coating liquid formulated by a coater over a surface of a substrate in such an amount of the coating liquid that would weigh after dried in a range of 1 to 50 g/m², preferably 3 to 10 g/m². As the coater on this process, air knife coater, bar coater, roll coater, blade coater, gravure coater, etc. may be used.

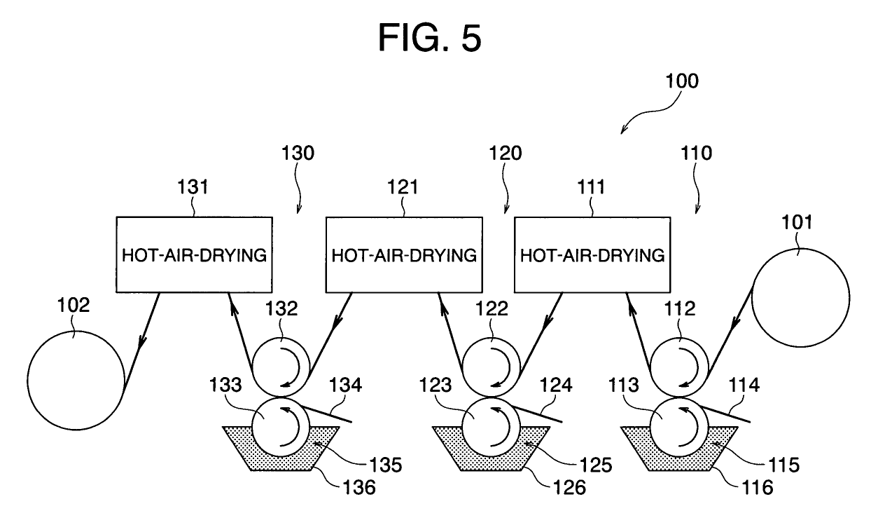

Thermosensitive coloring layers 4a, 4b, and 4c having different coring hues are formed integrally with ink receptive layer 3 using a gravure printing process. A gravure printing apparatus 100, as shown in FIG. 5, comprises a feeding roll 101 for feeding a continuous substrate, winding roll 102 that winds a first thermosensitive recording medium formed through a printing process, printing units 110, 120, and 130, hot air dryers 111, 121, and 131. Water-dispersion thermosensitive inks 115, 125, and 135 in ink pans 116, 126, and 136 are scooped up by gravure printing plates 113, 123, and 133, and excess water-dispersion thermosensitive inks 115, 125, and 135 out of the cells are removed by doctor blades 114, 124, and 134.

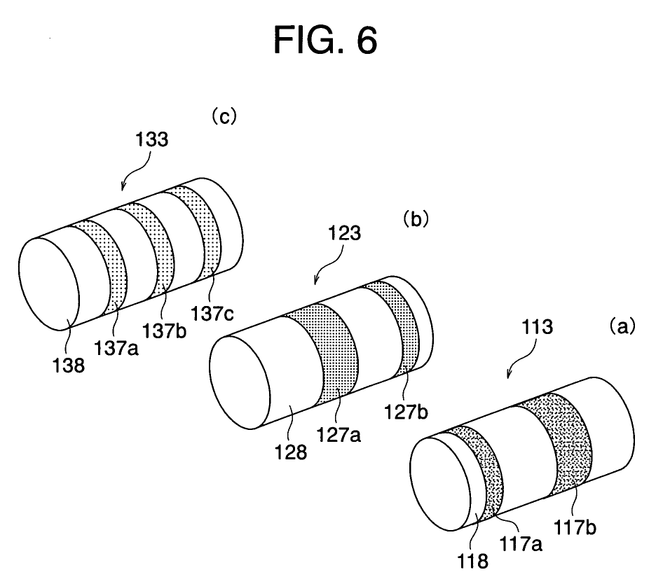

In reference to FIGS. 6a through 6c, on surfaces around cylinders 118, 128, and 138, gravure printing plates 113, 123, and 133 are formed respectively. On a surface of each gravure printing plate, a number of miniature dents, called “cells,” are collectively formed as a band surrounding the cylinder. The printing plates 113, 123, and 133 comprise 117a and 117b, 127a and 127b, and 137a and 137b, respectively. When the gravure printing plates rotate, water-dispersion thermosensitive inks 115, 125, and 135 of different colors enter these collective cells 117a and 117b, 127a and 127b, 137a and 137b, respectively. Water-dispersion thermosensitive inks 115, 125, and 135 are then transferred to substrates 2 having ink receptive layers 3, which are carried being interposed between pressure rollers 112, 122, 132, and gravure printing plates 113, 123, 133, respectively. Thus, thermosensitive coloring layers 4a, 4b, and 4c of different colors are continuously formed in parallel over the substrate 2 in a longitudinal direction of the substrate.

As appeared in FIGS. 6a through 6c, the cell bands of different colors in groups 117a and 117b, 127a and 127b, and 137a and 137b are arranged so as not to superimpose each other in a width direction of the cylinders 118, 128, and 138. In this arrangement of the cell bands of different colors that are mutually shifted, thermosensitive coloring layers 4a, 4b, and 4c can be formed in parallel extending in a longitudinal direction of substrate 2.

By selecting widths and lateral positions of the respective cell bands in groups of 117a and 117b, 127a and 127b, and 138a and 138b, thermosensitive coloring layers 4a, 4b, and 4c can be formed without gaps between the layers in the width direction of substrate 2. When different colors are coated using a first print unit 110, a second print unit 120, and a third print unit 130 of a gravure printing apparatus, the individual thermosensitive coloring layers are likely misaligned on their layer edges due to thermal extension/contraction or media transport errors. Occurrence of interspaces between the thermosensitive coloring layers of different colors, if happens somewhat, can be prevented by coating a lighter color ink before a darker ink so that the darker one is superposed over the lighter.

Gravure printing plates 113, 123, and 133 are etched plates having 175 lines and 40 μm in depth. The fewer the number of lines and the greater depth of the cells of a printing plate are, the thicker the thermosensitive coloring layer is formed and more concentrated the developed color appears. Then again, “streaking” and density unevenness likely occur. Therefore, the number of the lines and depth of the cells of a printing plate should be determined on terms of tradeoff between these color density and density unevenness. Thermosensitive recording medium 1 can be produced at desired lengths in a longitudinal direction of ink-coating in a direction (as characters are serially printed in a printer) by forming the thermosensitive coloring layers continuously in stripes.

A sequence of forming thermosensitive coloring layers 4 among them on a printing process is preferably to be determined such that ink of lightest color is coated first, then the second lighter one follows it, and so on. This is based on the following reason. A doctor blade generally tends to wear easier when used with aqueous inks than with other types of inks, and a worn doctor blade likely touches spots other than an intended area so that water-dispersion thermosensitive ink is coated elsewhere. In such a case, when a dark thermosensitive coloring layer is formed after a light color layer even if using such a worn doctor blade, color mixing becomes hard to spot as the dark layer superimposes the lighter one. In other respects, if a worn doctor blade is used with a darker ink, color mixing becomes hardly distinguished because spots of a coloring layer that unintended color ink could be accidentally touched on are not over an ink receptive layer but over a thermosensitive coloring layer of a lighter hue, and hence the amount of a darker ink to be transferred from the printing plate to the coloring layer is a little.

On a process of forming thermosensitive coloring layers 4a, 4b, and 4c as shown in FIGS. 1 though 3, red thermosensitive coloring layer 4c is first formed in ink by first print unit 110 of a gravure printing apparatus, blue layer 4a is next formed by second print unit 120, and lastly black layer 4b is formed by third print unit 130.

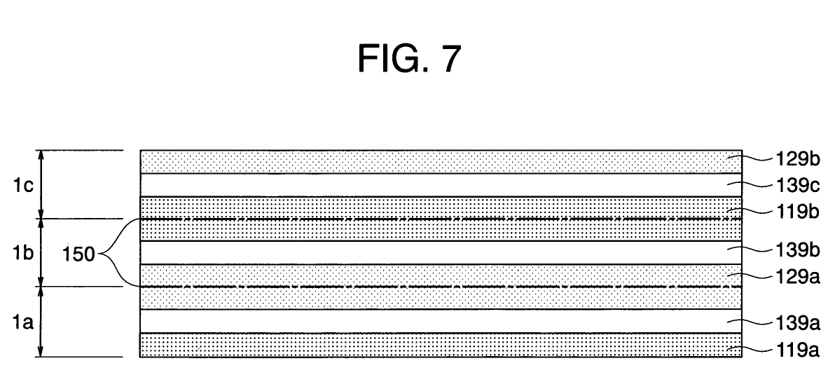

On thermosensitive recording medium 1, as shown in FIG. 7, which is to be divided later into several to become printing materials, the respective thermosensitive coloring layers 4a, 4b, and 4c are sequentially formed in stripes. That is, the thermosensitive coloring layers 119a and 119b are formed by cells bands 117a and 117b on the gravure printing plate (118); layers 129a and 129b are formed by cells bands 127a and 127b on the gravure printing plate (128); layers 139a and 139b are formed by cells bands 137a and 137b on the gravure printing plate (138).

If necessary, a protective layer is provided over the coloring layers, following formation of thermosensitive coloring layers 4a, 4b, and 4c on substrate 2. As shown in FIG. 7, a thermosensitive recording medium (referred as a first thermosensitive recording medium), in which the respective thermosensitive coloring layers are formed in parallel stripes over substrate 2 having ink receptive layer 3 extending in a longitudinal direction of the substrate 2, is split along a cut lines 150 by a splitter into plural thermosensitive recording mediums (referred as a second thermosensitive recording medium) having predetermined widths. Split lines are provided over and along thermosensitive coloring layers 129a and 129b. By slitting this thermosensitive recording medium along these split lines, thermosensitive recording mediums 1a, 1b, and 1c are produced. Second thermosensitive recording mediums that are split are wound on rolls at predetermined lengths so that a thermosensitive recording medium roll 10 is obtained.

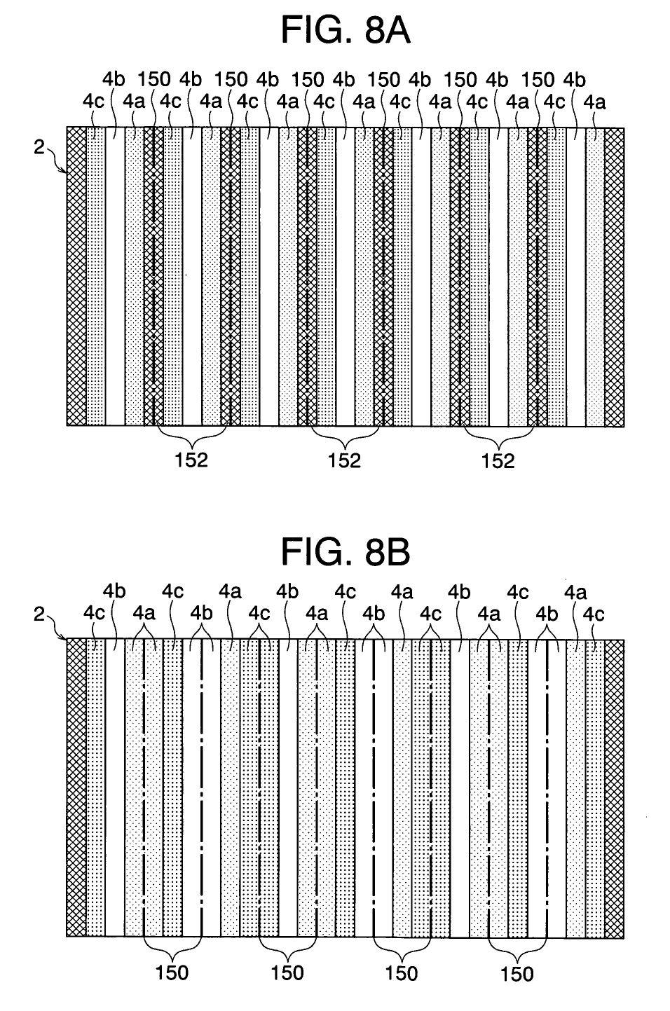

In the case that a number of thermosensitive recording mediums in each of which thermosensitive coloring layer are arranged in the order of 4a, 4b, and 4c as illustrated in FIG. 8A, are formed on a substrate, narrow gaps 152 having no thermosensitive coloring layer are provided between neighboring thermosensitive coloring layers 4a and 4c. Narrow gaps 152 become unusable areas in the thermosensitive recording mediums.

To avoid to produce such unusable areas as shown, thermosensitive coloring layers 4a, 4c, and 4c are formed though a printing process on substrate 2 having ink receptive layer 3 such that the neighboring thermosensitive coloring layers 4a and 4c interposed by split line 150 are united into a common coloring layer. Thermosensitive recording medium 1 is produced by splitting substrate 2 along the cutting line 150 provided over the common thermosensitive coloring layer 4. The common coloring layer is formed having a width of, for example, double normal width, if split thermosensitive coloring layers (from the common layer) would be set to the same width.

In FIG. 8B, seeing thermosensitive coloring layers 4a, 4b, and 4a of different hues, common coloring layers having a double width are arranged in the order of 4a, 4b, 4c and then 4a from the left. Assuming that these double-width coloring layers would be split on the center line on the respective portions, the coloring layers within the respective thermosensitive recording mediums 1 that have been split would have arrangements as in the order of 4c, 4b, 4a->4a, 4c, 4b->4b, 4a, 4c, and then the first color arrangement (4c, 4b, 4a) returns. In these thermosensitive recording mediums 1 split in this manner, although three different arrangements in the same colors combination are provided, unusable portions as seen in FIG. 8A are not created.

To form plural thermosensitive recording mediums having the same arrangement order of thermosensitive coloring layers 4a, 4b, and 4c on one substrate, arrangement of thermosensitive coloring layers 4 (119a, 119b, 129a, 129b, 139a, 139b, 139c) of one of neighboring thermosensitive recording mediums 1 is reversed. In actual recording by a thermal printer, images of the same pattern can be recorded by merely changing a direction of data transferring within a printer, since arrangement orders of the coloring layers in neighboring thermosensitive recording mediums 1 are mutually reversed. More specifically, in thermosensitive recording mediums 1 adjacent to each other (for example, 1a and 1b) as shown in FIG. 7, arrangement orders of the thermosensitive coloring layers formed in stripes are reversed to each other. In thermosensitive recording medium 1a, there are arranged red thermosensitive coloring layer 119a at the right, black thermosensitive coloring layer 139a in the middle, and blue thermosensitive coloring layer 129a at the left, whereas in neighboring thermosensitive recording medium 1b there are arranged blue thermosensitive coloring layer 129a at the right, black thermosensitive coloring layer 139b in the middle, and red thermosensitive coloring layer 119b at the left.

If cutting is made over thermosensitive coloring layers 119b and 129a, positional error of some 1 mm from the center line in the width direction may be allowed in view of recording accuracy of a printer.

Producing multiple thermosensitive recording mediums 1 by cutting in the middle of thermosensitive coloring layer instead of an unusable space yields advantages that narrow gaps 152 that lack thermosensitive coloring layers become unnecessary and occurrences of color mixing caused by a worn doctor blade can be reduced by reduction of boundary areas between thermosensitive coloring layers 4 of different colors.

As a material of substrate 2, paper may be used. When thermosensitive coloring layers 4 are formed by coating water-dispersion thermosensitive ink using a gravure printing machine, a paper is likely cockled. To prevent such cockles when used with a typical photogravure printing machine, a thickness of paper as substrate 2 of 90 g/m² in terms of basis weight, preferably 100 g/m², is required.

So far, there has been described an example in which thermosensitive coloring layers in stripes were formed over ink receptive layer 3 that was provided on a continuous substrate 2 by coating in stripes a water-dispersion thermosensitive ink containing an electron-donating compound and electron-accepting compound using a gravure printing plate. As an alternative example, in view of preventing “streak,” it is more effective to form the coloring layers by coating water-dispersion thermosensitive ink containing at least an electron-donating compound over ink receptive layer 3 in which an electron-accepting compound is impregnated.

For the electron-accepting compound, for example, a developer can be used. To be more specific, oxides such as phenols, phenolic metallic salts, carboxylic metallic salts, sulfonic acid, sulfonate, phosphoric acid, phosphoric metallic salts, acid ester phosphate, phosphorous acids, phosphorous acid metallic salts may be used. These materials may be used either alone or mixed as well.

For the electron-donating compound, for example, a leuco dye can be used. To be more specific, usable as a black dye are PSD-150, PSD-184, PSD-300, PSD-802, PSD-290 of Nippon Soda Co., Ltd.; CP-101, BLACK-15, ODB, ODB2 of Yamamoto Chemicals Inc.; BLACK-100, S-205, BLACK-305, BLACK-500 of Yamada Kagaku Co., Ltd.; and TH-107 of Hodogaya Chemical Co., Ltd. Usable as a blue dye are CVL, BLUE-63, BLUE-502 of Yamamoto Chemicals Inc.; BLUE-220 of Yamada Kagaku Co., Ltd.; and BLUE-3 of Hodogaya Chemical Co., Ltd. Usable as a red dye are PSD-HR, PSD-P, PSD-0 of Nippon Soda Co., Ltd.; Red-3, Red-40 of Yamamoto Chemicals Inc.; Red-500, Red-520 of Yamada Kagaku Co., Ltd.; and Vermilion-DCF, Red-DCF of Hodogaya Chemical Co., Ltd. Among the dyes indicated in the above, more than one kind may be mixed.

Dyes usable for other colors are: for green, PSD-3D (Nippon Soda Co. Ltd.), ATP (Yamada Kagaku Co., Ltd.), Green DCF (Hodogaya Chemical Co., Ltd.), etc.; for yellow, F. Color Yellow-17 (Yamamoto Chemicals Inc.); for orange, PSD-0 (Nippon Soda Co. Ltd.), Orange 100 (Yamada Kagaku Co., Ltd.), etc.

In the above, descriptions were made for example of using color combination of blue, black, and red for the respective thermosensitive coloring layers 4a, 4b, and 4c. This color combination is well balanced and suitable for multicolor thermosensitive recording medium 1 as used for a price card. However, colors usable are not limited to this combination.

Usable as the binder resins are water-soluble resins such as starches, celluloses, and polyvinyl alcohols, and latex resins such as polyvinyl acetate, polyurethane, and polyacrylic ester. These materials may be used either alone or mixed as well.

As needed, sensitizers such as waxes, naphthol derivative, biphenyl derivative, polyether derivative, and diester carbonate derivative, print-head abrasion resistance agents and anti-sticking agents such as zinc stearate, amide stearate, and calcium carbonate may be used.

To form thermosensitive coloring layers 4a, 4b, and 4c, first, water-dispersion thermosensitive ink is prepared by dispersing and mixing in water a developer (electron-accepting compound) a leuco dye (electron-donating compound), binder resin, and if necessary, pigments such as a sensitizer, print-head abrasion resistance agent, anti-sticking agent. If needed, various additives such as a modified resin, such as denatured sulfonic polyvinyl alcohol, dispersant such as a surfactant, defoamer, ultraviolet absorbent, antiseptic, may be mixed in the ink.

A sensitizer is used to enhance color developing sensitivity by binding between an electron-accepting compound and an electron-donating compound. Although an ideal material for the sensitizer differs depending on an electron-accepting compound used and electron-donating compound used for thermosensitive coloring layers 4, for example, sensitizer HS-3520, manufactured by Dainippon Ink & Chemicals Co., Ltd. may be used.

In the above example, descriptions have been made that a width of the thermosensitive coloring layer 4 needs to be more than 10 mm and more than one tenth of a width of thermosensitive recording medium 1. However, the width may be smaller than that depending on applications, and those dimensions may be selected accordingly.

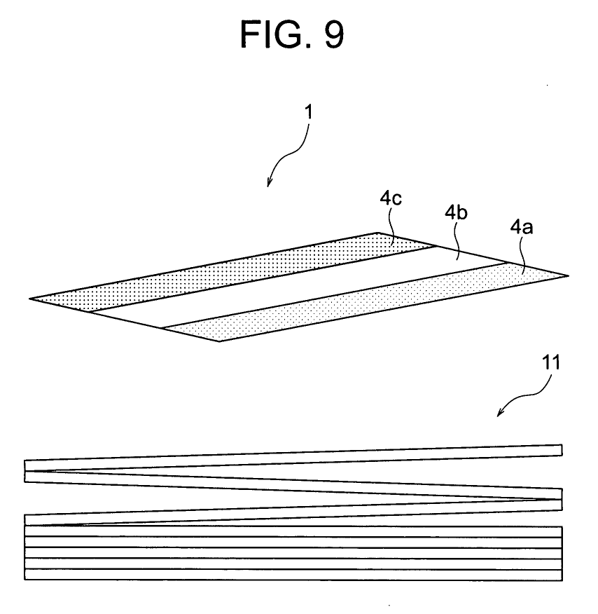

In the above example, description has also been made for thermosensitive recording medium roll 10 for recording by a thermal printer (not shown) as an applied form of thermosensitive recording medium 1. Thermosensitive recording medium roll 10 can be transformed to a folded thermosensitive recording medium 11, as shown in FIG. 9, by perforating the medium roll. In this case, thermosensitive recording medium 1 as produced through a normal printing process can provide thermosensitive recording medium 11 having a fixed folding length. However, this folding length can be easily changed because printing length of thermosensitive recording medium 1 is flexible.

In the above example, one thermosensitive recording medium 1 is provided such that thermosensitive coloring layers each having a color different from other are formed in stripes. If at least two different colors are provided, more than one thermosensitive coloring layers 4 having the same color may be formed.

Hereinafter, specific compositions of thermosensitive recording medium 1 according to the present invention will be described by using examples. However, the invention is not restricted to such examples. In the examples below, unit “part(s)” means “part(s) by weight.”

### EXAMPLE 1

Formation of Ink Receptive Layer

| | | |
|---|---|---|
| Calcined kaolin (pigment in ink receptive layer 3) | 100 | parts |
| (KAOCAL (brand name), available from | | |
| Shiraishi Calcium Kaisha Ltd.) | | |
| Hydrophilic silica (pigment in ink receptive layer 3) | 11 | parts |
| (Nipsil E-220A (brand name), manufactured by | | |
| Tosoh Silica Corp.) | | |
| Sodium polyacrylate (dispersant) | 1 | part |
| Water | 280 | parts |

A pigment dispersion liquid of hydrophilic silica was prepared by dispersing the above components using a homogenizer. Then, a coating liquid for ink receptive layer 3 was prepared by adding the following components to this pigment dispersion liquid and mixing them using a homogenizer.

| | |
|---|---|
| Styrene-butadiene copolymer latex | 55 parts |
| (48%-SBR dispersion liquid, manufactured by JSR) | |
| Phosphate ester starch | 37 parts |
| (MS-4600 (20% aqueous solution), manufactured by Nihon | |
| Shokuhin Kako Co., Ltd.) | |

Ink receptive layer 3 was formed such that the coating liquid prepared in the above process is coated on substrate 2 (a quality paper) having basic weight of 90 g/m² by a micro-gravure coater at a medium transport speed of 50 meter/minute at drying temperature of 100 degrees C. in an amount of the coating material that would weigh 8 g/m² after dried.

Formation of thermosensitive coloring layers

| | | |
|---|---|---|
| Leuco dye dispersion liquid (30% of solid | 50 | parts |
| component) | | |
| Blue (CVL, manufactured by Yamamoto | | |
| Chemicals Inc.) | | |
| Black (ODB-2, manufactured by Yamamoto | | |
| Chemicals Inc.) | | |
| Red (Vermilion-DCF, manufactured by | | |
| Hodogaya Chemical Co., Ltd.) | | |
| Leuco dye dispersion liquid of each color | | |
| was prepared by dispersing each of above | | |
| leuco dyes in water with a 5% dispersant | | |
| of GOHSERAN L-3266 (manufactured by | | |
| The Nippon Synthetic Chemical Industry Co., | | |
| Ltd.) and using a sand mill to obtain an | | |
| average particle size of 0.8 μm. | | |
| Developer dispersion liquid (40% of solid | 75 | parts |
| component) (D-8 manufactured by Nippon Soda | | |
| Co., Ltd.) (F-647 (dispersion liquid using | | |
| D-8) manufactured by Chukyo Yushi Co., Ltd.) | | |
| Sensitizer dispersion liquid (30% of solid | 100 | parts |
| component) (HS-3520, manufactured by | | |
| Dainippon Ink & Chemicals Co., Ltd.) | | |

This sensitizer dispersion liquid was prepared by dispersing the sensitizer as a dispersant with a 5% GOHSERAN L-3266 (manufactured by The Nippon Synthetic Chemical Industry Co., Ltd.) and using a sand mill so as to obtain an average particle size of 0.8 μm.

| | |
|---|---|
| Lubricant dispersion liquid (30% of solid component) | 32 parts |
| (Zinc stearate: HIDRIN Z-7-30, manufactured by | |
| Chukyo Yushi Co., Ltd.) | |
| Recrystalization-inhibitor dispersion liquid | 20 parts |
| (35% of solid component) | |
| DH43, manufactured by Asahi Denka Co., Ltd. | |
| HYDRIN F-165 manufactured by Chukyo Yushi Co., Ltd. | |
| Calcium carbonate dispersion liquid (30% of solid component) | 50 parts |
| (KARURAITO-KT, manufactured by Shiraishi Calcium Kaisha) | |

A calcium carbonate dispersion liquid was prepared by dispersing the sensitizer in water as a dispersant with a 5% GOHSERAN L-3266 (manufactured by The Nippon Synthetic Chemical Industry Co., Ltd.) and using a sand mill so as to obtain an average particle size of 0.8 μm.

| | |
|---|---|
| 10%-PVA solution | 53 parts |
| (PVA110, manufactured by Kralle Co., Ltd.) | |
| Surfactant (10% of solid component) | 33 parts |
| (ADEKACOL EC4500, manufactured by Asahi Denka Co., | |
| Ltd.) | |
| Water | 25 parts |

The water-dispersion thermosensitive inks having different color hues of blue, black, and red were formulated by mixing the above developer dispersion liquid, sensitizer dispersion liquid, lubricant dispersion liquid, recrystalization-inhibitor dispersion liquid, calcium carbonate dispersion liquid, 10%-PVA solution, surfactant, and water with the respective leuco dye dispersion liquids of blue, black, and red.

Each of the water-dispersion thermosensitive inks prepared in the above process was adjusted so that a viscosity of the ink falls in a range between 30 and 40 cps (measured with an E type viscometer of Tokyo Keiki Co., Ltd.) and the surface tension becomes 30 mN/m or lower (measured using a K12-Mk5 surface tension balance, manufactured by Kruss GmbH). The surface tension of the ink needs to be lowered using a surfactant, particularly when printing using an engraved plate, since the ink having a high surface tension makes it difficult to let the ink intrude into dents on a printing plate.

These water-dispersion thermosensitive inks were coated on ink receptive layer 3 using a photogravure printing machine (etched plate having 150 lines in cell density and 40 μm in cell depth), so that thermosensitive coloring layers 4 of thermosensitive recording medium 1 were formed. The etched plate that was used in this process had 150 lines in cell density and 40 μm in cell depth, which permits continuously coating in stripes for the respective color inks as shown in FIGS. 6a through 6c. The condition of the coating was set to 80 degrees C. for dry temperature (medium length for drying was 11 meters) and 50 meters/minutes for medium transport speed. The coating sequence was in the order of red thermosensitive coloring layer 4c, blue thermosensitive coloring layer 4a, and black thermosensitive coloring layer 4b, as described earlier. Using the etched plate having 150 lines in cell density and 40 μm in cell depth that permits continuously coating in stripes for the respective inks as shown in FIGS. 6a through 6c, red thermosensitive coloring layers 119a and 119b, then blue thermosensitive coloring layers 129a and 129b, and black thermosensitive coloring layers 139a and 139b were sequentially coated.

As it happens normally, wearing of doctor blades 114, 124, and 134 caused hazing in a stripe at a coating length of some 15000 to 20000 meters, which then caused color mixing between thermosensitive coloring layer 4a, 4b, and 4c. However, by coating the inks in the above sequence, this color mixing between thermosensitive coloring layer 4a, 4b, and 4c in stripes did not occur even at some 20000 to 25000 meters of coating, and the number of changing of doctor blades 114, 124, and 134 could be reduced. This is because a thermosensitive coloring layer having dark color overrode a thermosensitive coloring layer having light color so that it became undistinguished even if hazing occurred lightly.

“Hazing” means a phenomenon that water-dispersion thermosensitive ink that remains on the surface of a printing plate without being removed by doctor blade is lightly transferred to a surface of a blank area on a recording medium.

Because regions adjacent to dense color thermosensitive coloring layer 4 that is subsequently coated are not ink receptive layer 3 but other thermosensitive coloring layers in stripes, the amount of transferred water-dispersion thermosensitive ink of dense color having hazing is little, and therefore such color mixing is hardly distinguished.

As can be seen in FIG. 7, arrangement orders of thermosensitive coloring layers in stripes within the respective thermosensitive recording mediums 1a and 1b are reciprocal to each other and the two mediums share a common thermosensitive coloring layer 129a. That the striped patterns in the thermosensitive recording mediums 1 that neighbor to each other are arranged in reverse orders and a common thermosensitive coloring layer is formed in the two mediums is considered to have brought the result of reduction in number of spots of color mixing due to hazing and frequency of replacing doctor blades.

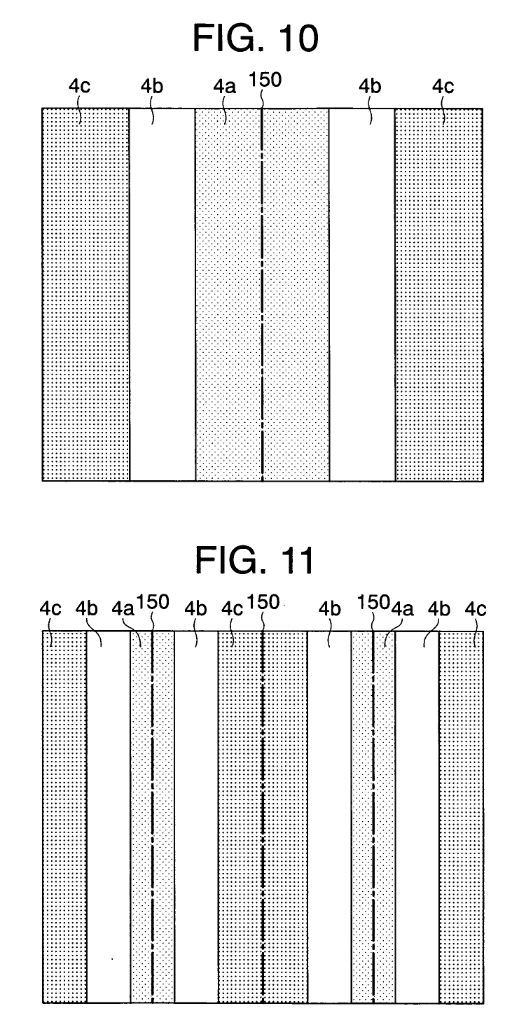

A protective layer was formed on thermosensitive recording medium 1 thus obtained, on which thermosensitive coloring layers 4 have previously been formed, by coating OCA-5 of Nippon Kayaku Co., Ltd. with a bar coater in such an amount that the coating after dried would weigh 1 g/m². The thermosensitive recording medium is slit along cutting line 150 by a slitter as shown in FIG. 10, and is subjected to a calendar process so that plural thermosensitive recording mediums 1 in stripes were obtained.

FIG. 10 illustrates thermosensitive recording medium 1 in Example 1. It shows a structure in which two thermosensitive recording mediums were produced by coating water-dispersion thermosensitive ink on a substrate having an ink receptive layer coated thereover and cutting the coated medium along cutting line 150. This thermosensitive recording medium 1 obtained in Example 1 has the following features:

| | |
|---|---|
| Longitudinal patterns: | Continuous stripes |
| Width of thermosensitive recording medium 1: | 100 mm |
| Widths of the respective coloring layers: | Red, 40 mm; |
| | Black, 30 mm; |
| | Blue, 30 mm |
| Sequence of coating: | Red −> Blue −> Black |

Since thermosensitive recording medium 1 obtained in this manner is provided with thermosensitive coloring layers 4a (blue), 4b (black), and 4c (red) formed in continuous stripes in an ink-coating direction, a recording length can be flexibly selected.

Because orders of the respective thermosensitive coloring layers at both sides in respect to cutting line 50 are arranged mutually in reversed order, the number of boundaries between different thermosensitive coloring layers can be reduced. Also, by coating ink of light color before coating the darker, the number of replacement of a doctor blade can be reduced.

Since the width of each of thermosensitive coloring layers 4 in stripes is more than one tenth of a total medium width and at least 10 mm, they look well balanced visually. Particularly, when a bar-code is recorded on blue thermosensitive coloring layer 4a or black thermosensitive coloring layer 4b, reading accuracy of bar-codes showed good results.

When thermosensitive recording medium roll 10 is produced by rolling the medium in a predetermined length, since stripe patterns interposed by cutting line 150 are reversed, it is useful to put marks on winding core of the medium that indicates arrangements of the stripe coloring layers.

### EXAMPLE 2

FIG. 11 illustrates a structure of an original thermosensitive recording medium in Example 2, from which four thermosensitive recording mediums 1 were produced such that water-dispersion thermosensitive inks were coated on a substrate having an ink receptive layer formed thereover and the coated medium was cut along cutting lines 150. In this example, the width of thermosensitive recording medium 1 was made to be 50 mm, and widths of the respective thermosensitive coloring layers were set to the following dimensions. The conditions otherwise remain the same as Example 1.

| | |
|---|---|
| Longitudinal patterns: | Continuous stripes |
| (Arrangements of striped thermosensitive | |
| coloring layers 4 in neighboring | |
| thermosensitive recording medium 1 are | |
| reversed to each other) | |
| Width of thermosensitive recording medium 1: | 50 mm |
| Widths of the respective coloring layers: | Red, 20 mm; |
| | Black, 20 mm; |
| | Blue, 10 mm |
| Sequence of coating: | Red −> Blue −> Black |

Thermosensitive recording medium 1 obtained in this example exhibited excellent results in bar-code reading by a scanner and dimensional balancing between thermosensitive coloring layers of different colors, and the same effect as in Example 1 was obtained in respect to color mixing due to a worn doctor blade.

### EXAMPLE 3

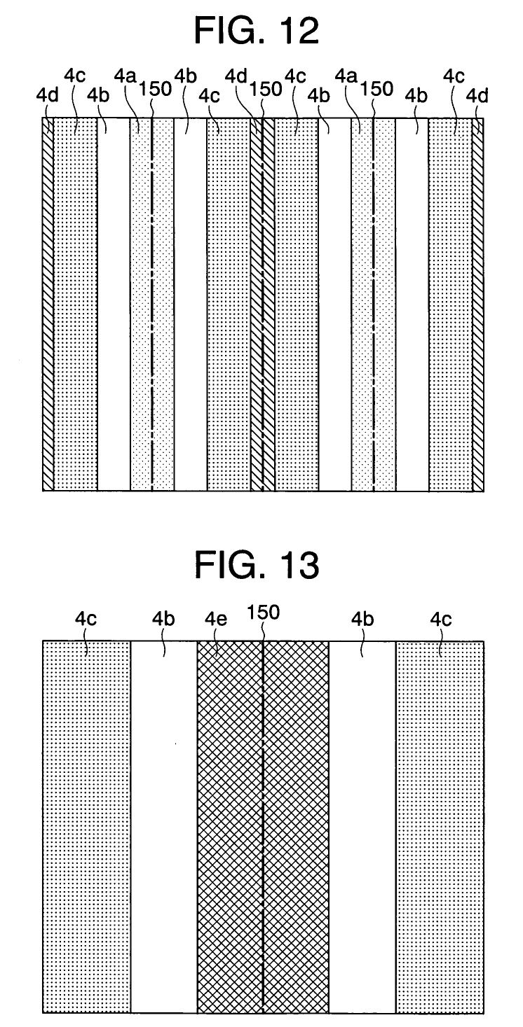

In this example, as shown in FIG. 12, blue thermosensitive coloring layer 4d and blue thermosensitive coloring layer 4a are simultaneously coated on the other side of black thermosensitive coloring layer 4b interleaving red thermosensitive coloring layer 4c of thermosensitive recording medium 1. These thermosensitive recording mediums 1 were produced by splitting blue thermosensitive coloring layer 4d and blue thermosensitive coloring layer 4a along cutting lines on the respective layers, and the width of red thermosensitive coloring layer 4b was change to provide thermosensitive coloring layer 4d. Other conditions were the same as in Example 2.

| | |
|---|---|
| Longitudinal patterns: | Continuous |
| (Arrangements of striped thermosensitive | stripes |
| coloring layers 4 in neighboring | |
| thermosensitive recording medium 1 are | |
| reversed to each other) | |
| Width of thermosensitive recording medium 1: | 50 mm |
| Widths of the respective coloring layers: | Blue, 5 mm; |
| | Red, 20 mm; |
| | Black, 15 mm; |
| | Blue, 10 mm |
| Sequence of coating: | Red −> Blue |
| | (4a, 4d) −> Black |

Since this example is the same as Example 2 in the condition except that thermosensitive coloring layer 4d was added, the same effects as in Example 2 were obtained on blue thermosensitive coloring layer 4a, red thermosensitive coloring layer 4b, and black thermosensitive coloring layer 4c. Thermosensitive coloring layer 4d cannot be applied for bar-code recording, but can be used for marking an underline for underscoring characters of recorded contents. In this sense, 10 mm or even less is sufficient for the width of the layer. In respect to color mixing due to a worn doctor blade, the similar effect to Example 2 was obtained. This means that the effect can be obtained even if two thermosensitive coloring layers 4 of the same color are provided on thermosensitive recording medium 1.

### EXAMPLE 4

In Example 4, as shown in FIG. 13, two thermosensitive recording mediums were produced by coating water-dispersion thermosensitive on a substrate having an ink receptive layer coated thereover and cutting the coated medium along cutting line 150. Blue thermosensitive coloring layer 4a in Example 1 was substituted by green thermosensitive coloring layer 4e.

The process conditions were the same as in Example 1 except of changing leuco dye from CVL to Green DCF (manufactured by Hodogaya Chemical Co., Ltd.) to obtain green thermosensitive coloring layer 4e.

| | |
|---|---|
| Longitudinal patterns: | Continuous stripes |
| Width of thermosensitive recording medium 1: | 100 mm |
| Widths of the respective coloring layers: | Red, 40 mm; |
| | Black, 30 mm; |
| | Green, 30 mm |
| Sequence of coating: | Red −> Green −> Black |

Because the conditions are alike to Example 1 except substitution of blue thermosensitive coloring layer 4a by green thermosensitive coloring layer 4e, thermosensitive recording medium 1 obtained in this example exhibited excellent results in bar-code reading and dimensional balancing between thermosensitive coloring layers of different colors, and the same effect as in Example 1 was obtained in respect to color mixing due to a worn doctor blade.

### EXAMPLE 5

In Example 5, as shown in FIG. 8B, although arrangements of blue thermosensitive coloring layer 4a, black thermosensitive coloring layer 4b, and red thermosensitive coloring layer 4c are the same in all the thermosensitive recording mediums 1, cutting line 150 were provided in the order of thermosensitive coloring layers 4a, 4b, 4c, 4a, 4b, 4c . . . . from the left. Obtained thermosensitive recording mediums 1 by splitting the medium along these lines were in a combination of thermosensitive coloring layers 4c 4b 4a, 4a 4c 4b, 4b 4a 4c, 4c 4b 4a, . . . from the left. Other features are the same as in Example 1.

| | |
|---|---|
| Longitudinal patterns: | Continuous stripes |
| Width of thermosensitive recording medium 1: | 100 mm |
| Widths of the respective coloring layers: | Red, 40 mm; |
| | Black, 30 mm; |
| | Green, 30 mm |
| Sequence of coating: | Red −> Green −> Black |

Unlike Example 1, three patterns of thermosensitive recording mediums 1 were separated from one substrate 2. All of these three thermosensitive recording mediums 1 exhibited excellent results in terms of bar-code reading and dimensional balance in thermosensitive coloring layers of different colors, and the same effect as in Example 1 was obtained as to color mixing due to a worn doctor blade.

In this example, since three arrangements of different colors of thermosensitive coloring layers were produced, after separation into thermosensitive recording medium 1 it becomes difficult to distinguish those mediums before developing colors in thermosensitive coloring layers 4. To differentiate these three kinds of thermosensitive recording mediums, when substrate 2 is split and individual thermosensitive recording mediums 1 are rolled at predetermined lengths, it would become convenient if marks are made on surfaces or backs of the respective thermosensitive recording medium 1 at their ends after being rolled on winding cores so that the arrangements of the respective thermosensitive coloring layers 4 can be differentiated.

### COMPARATIVE EXAMPLE 1

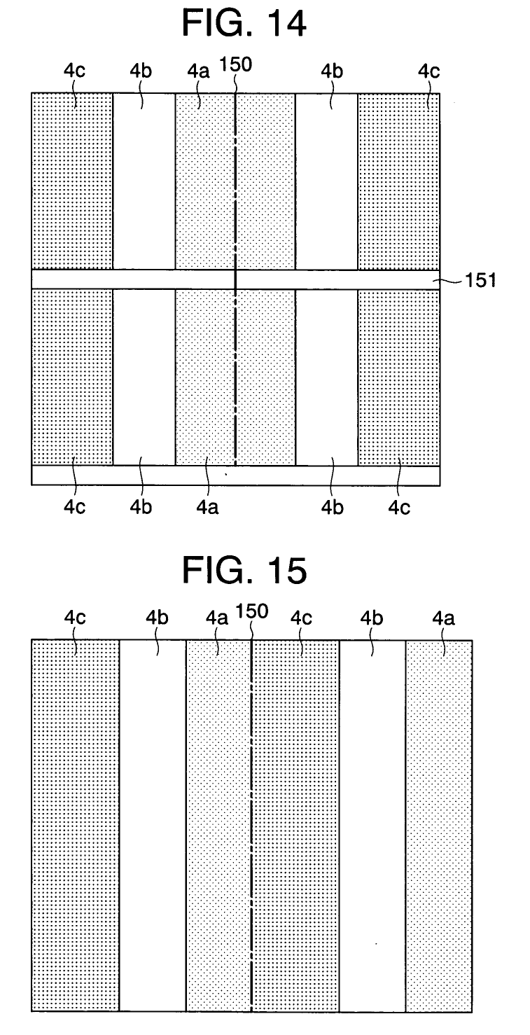

In Comparative Example 41, as seen in FIG. 14, there are provided a discontinued zone 151 in the coatings of thermosensitive recording medium 1. Thermosensitive coloring layers forms discontinued stripes in a longitudinal direction. Other conditions are the same as in Example 1.

| | |
|---|---|
| Longitudinal patterns: | Discontinuous stripes |
| (Arrangements of striped thermosensitive | |
| coloring layers 4 in neighboring | |
| thermosensitive recording medium 1 are | |
| reversed to each other) | |
| Width of thermosensitive recording medium 1: | 100 mm |
| Widths of the respective coloring layers: | Red, 40 mm; |
| | Black, 30 mm; |
| | Blue, 30 mm |
| Sequence of coating: | Red −> Blue −> Black |

Because striped thermosensitive coloring layers 4 are discontinuous, its application in a longitudinal direction is limited. Its performances otherwise are the same as those of Example 1. In terms of production, because a gravure printing plates used for the respective thermosensitive coloring layer 4a, 4b, and 4c need to be aligned not only in a width direction but also in a longitudinal direction of substrate 2, quite a little of substrate 2 and water-dispersion thermosensitive inks are wasted for the alignments.

### COMPARATIVE EXAMPLE 2

In Comparative Example 2, as seen in FIG. 15, an arrangement of stripe patterns of one thermosensitive recording medium 1 during ink-coating is identical to that of neighbor thermosensitive recording medium 1, and cutting line 150 was provided on the boundary between thermosensitive coloring layer 4a of one thermosensitive recording medium 1 and thermosensitive coloring layer 4c of neighbor thermosensitive recording medium 1. Otherwise, the condition was the same as in Example 1.

| | |
|---|---|
| Longitudinal patterns: | Continuous stripes |
| (Arrangements of striped thermosensitive | |
| coloring layers 4 in neighboring | |
| thermosensitive recording medium 1 are | |
| the same, and cutting line is placed on | |
| the boundary between thermosensitive | |
| coloring layer 4a of one thermo- | |
| sensitive recording medium 1 and | |
| thermosensitive coloring layer 4c | |
| of neighbor thermosensitive recording | |
| medium 1) | |
| Width of thermosensitive recording medium 1: | 100 mm |
| Widths of the respective coloring layers: | Red, 40 mm; |
| | Black, 30 mm; |
| | Blue, 30 mm |
| Sequence of coating: | Red −> Blue −> Black |

Although performances in respect to bar-code reading, dimensional balance between thermosensitive coloring layers 4 of different colors, and flexibility in a longitudinal direction were the same as Example 1, color mixing occurred earlier due to increased number of boundaries between thermosensitive coloring layers 4a, 4b, and 4c of different colors. In addition, accurate cutting along cutting line 150 was required.

### COMPARATIVE EXAMPLE 3

In Comparative Example 3 a sequence of ink-coating on thermosensitive recording medium 1 was changed (the sequence of ink-coating was reversed). Otherwise, the condition was unchanged.

| | |
|---|---|
| Longitudinal patterns: | Continuous stripes |
| Width of thermosensitive recording medium 1: | 100 mm |
| Widths of the respective coloring layers: | Red, 40 mm; |
| | Black, 30 mm; |
| | Blue, 30 mm |
| Sequence of coating: | Black −> Blue −> Red |

As to bar-code reading and dimensional balance between thermosensitive coloring layers 4 of different colors, the same performance results as in Example 1 were obtained. However, owing to different sequence of ink-coating from that of Example 1, color mixing between neighboring thermosensitive coloring layers 4 likely occurred when even little hazing has occurred as a result of a worn-out doctor blade on the black layer. For this reason, frequency of replacement of the doctor blade increased comparing to Example 1.

### COMPARATIVE EXAMPLE 4

In Comparative Example 4, as seen in FIG. 8A, a number of thermosensitive recording mediums 1 each having different color layers in stripes were formed on substrate 2, and cutting lines 150 were provided over gaps 152 on substrate 2, not over thermosensitive coloring layers. In this comparative example, since useless substrate areas are required by the need of the gaps 152, the production cost increases.

### COMPARATIVE EXAMPLE 5

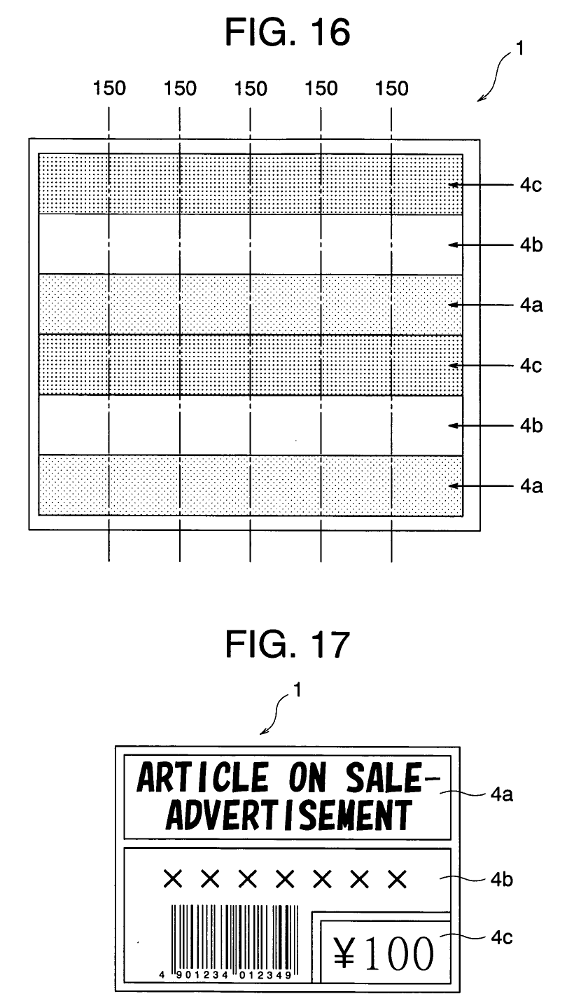

In Comparative Example 5, as seen in FIG. 16, a number of thermosensitive coloring layers 4a, 4b, and 4c of the respective colors were formed extending in a width direction of substrate 2, partially in a longitudinal direction (coating direction) of substrate 2. Sequence of ink-coating is the same as in Example 1 and cutting lines 150 were provided over thermosensitive coloring layers 4. In this structure, although position alignment for thermosensitive coloring layer can be made roughly, each coloring layer needs to be individually aligned because thermosensitive coloring layer 4a, 4b, and 4b are discontinued in a longitudinal direction of substrate 2. Alignments in a longitudinal direction of substrate 2 are more likely subject to stretching of substrate 2 comparing to alignment in a width direction of substrate 2, and therefore alignment errors can likely be created. Relating to such position alignments, some of the substrate are wasted. Besides, there is no flexibility on recording length in a longitudinal direction of substrate 2.

Table 1 below is a comparison table between Examples 1 through 4 and Comparative Examples 1 through 5.

TABLE 1

| | Thermo- | Color | | Ink | Freedom of | Time of | | | |
|---|---|---|---|---|---|---|---|---|---|
| | sensitive | layers | Pos. of | Coating | Recording | Blade | Cut'ng | Wasted | Overall |
| | coloring layer | Arrangement | Cutting line | Sequence | Length | Replacement | Accuracy | Substrate | Judgment |
| Ex. 1 | Continuous | Reciprocal | On Thermo | From | Variable | Long | Not Req'd | None | A |
| | | | Sens. Layer | Light Color | | | | | |
| Ex. 2 | Continuous | Reciprocal | On Thermo | From | Variable | Long | Not Req'd | None | A |
| | | | Sens. Layer | Light Color | | | | | |
| Ex. 3 | Continuous | Reciprocal | On Thermo | From | Variable | Long | Not Req'd | None | A |
| | | | Sens. Layer | Light Color | | | | | |
| Ex. 4 | Continuous | Reciprocal | On Thermo | From | Variable | Long | Not Req'd | None | A |
| | | | Sens. Layer | Light Color | | | | | |
| Ex. 5 | Continuous | Same order | On Thermo | From | Variable | Long | Not Req'd | None | A |
| | | | Sens. Layer | Light Color | | | | | |
| Comp. | Discon- | Reciprocal | On Thermo | From | Limited | Long | Not Req'd | None | C |
| Ex. 1 | tinuous | | Sens. Layer | Light Color | | | | | |
| Comp. | Continuous | Same order | On | From | Variable | Short | Req'd | None | C |
| Ex. 2 | | | Boundary | Light Color | | | | | |
| Comp. | Continuous | Reciprocal | On Thermo | From | Variable | Short | Not Req'd | None | B |
| Ex. 3 | | | Sens. Layer | Dark Color | | | | | |
| Comp. | Continuous | Same order | On | From | Variable | Long | Not Req'd | Yes | C |
| Ex. 4 | | | Substrate | Light Color | | | | | |
| Comp. | Discon- | Reciprocal | On Thermo | From | Limited | Long | Not Req'd | None | C |
| Ex. 5 | tinuous | | Sens. Layer | Light Color | | | | | |

Term “continuous” indicated in Table 1 in a cell means a medium sample in which thermosensitive coloring layers are continuously formed in a longitudinal direction, and term “discontinuous” in a cell means that discontinued regions 151 (as shown in FIG. 14) are created in a medium sample.

Term “same” under the column of “Arrangement of thermosensitive coloring layers” means that thermosensitive coloring layers of different colors in neighboring thermosensitive recording mediums 1 are arranged in the same order, and term “reciprocal” means that thermosensitive coloring layers of different colors in neighboring thermosensitive recording mediums 1 are arranged mutually in reversed order in a transverse direction.

Term “Position of cutting line” as an item in Table 1 means, a position of cutting line 150 which is placed “over a thermosensitive coloring layer” in Examples 1 through 5, “between neighboring thermosensitive coloring layers 4 in Comparative Example 2, and “on a gap on substrate 2” in Comparative Example 4.

Term “From a light color” under the column of “Ink-coating sequence” in Table 1 means that a light color of a thermosensitive coloring layer is formed prior to a darker color of thermosensitive coloring layer, and “From darker color” means coating inks in any orders other than the “order from a lighter color.”

Term “Freedom of recording length” means a degree of freedom in respect to a recordable length on thermosensitive recording medium 1 when characters or images are recorded by a thermal printer.

Term “Frequency of blade replacement means frequency of replacements of doctor blade on a gravure printing process.

Term “Cutting accuracy” means whether or not cutting of a medium requires a more accuracy than a normal cutting.

Overall judgment was made and ranked at levels of A, B, and C as in the order from “Superior” depending on how much each sample satisfies requirements of the evaluation items above-mentioned.

From results of the comparisons, it can be seen that Examples 1 through 5 are superior to Comparative Examples 1 through 5 in respect to freedom of recording length (“Variable”: variable setting of recoding length possible; “Limited”: length limited), Time of replacement for a doctor blade (“Long”: replacement required due to occurrence of color mixing after its use for 20,000 meters of medium; “Short”: replacement required due to occurrence of color mixing before its use for 20,000 meters of medium), requirement for cutting accuracy (Not required; Required), and overall judgment (based on the performances in Example 1 as A rank, rank B and rank C are subjectively judged in terms of flexibility of recording length, replacement time for a doctor blade, and requirement for cutting accuracy).

In the examples and comparative examples described above, quality papers of 90 g/m² were used. If substrates having basic weight of less than 90 g/m² are used, cockles likely occur during a drying process after thermosensitive coloring layers 4 are formed.

Normally, printing apparatus are not provided with a vapor-steaming means that prevents occurrence of cockling on a substrate by applying vapor steam to it from back of a substrate. To obtain a substrate having a stable quality using normal printing apparatus without having cockles, a thickness of some 90 g/m², preferably 100 g/m², is needed. It is preferable to use a lower limit as long as cockles are not developed, because increasing its thickness increase its cost. Therefore, some 100 g/m² is considered optimum.

In the above Examples and Comparative Examples, gravure printing process was used. However, printing process need not be limited to gravure printing, and may also be used as long as they permit continuous coating of water-dispersion thermosensitive ink containing 30% of solid components.

Numerous modifications and variations of the present invention are possible in light of the above teachings. It is therefore to be understood that, within the scope of the appended claims, the present invention can be practiced in a manner other than as specifically described therein.

1. A multicolor thermosensitive recording medium developing a plurality of hues comprising:
a substrate rolled in a longitudinal direction; and
at least a first and second thermosensitive coloring layers formed on the substrate, the first thermosensitive coloring layer developing a first hue and having a first width, and the second thermosensitive coloring layer developing a second hue different from the first hue and having a second width,
wherein the first and second thermosensitive coloring layers are continuously formed in parallel to each other in the longitudinal direction of the substrate.

2. A multicolor thermosensitive recording medium according to claim 1, wherein the first and second thermosensitive coloring layers partially overlap to each other.

3. A multicolor thermosensitive recording medium according to claim 1, wherein the substrate has an ink receptive layer and the first and second thermosensitive coloring layers each includes a water-dispersion thermosensitive ink comprising at least an electron-accepting compound and an electron-donating compound which is applied on the ink receptive layer using a printing process.

4. A multicolor thermosensitive recording medium according to claim 1, wherein the substrate has an ink receptive layer comprising at least an electron-accepting compound and the first and second thermosensitive coloring layers each includes a water-dispersion thermosensitive ink comprising at least an electron-donating compound which is applied on the ink receptive layer using a printing process.

5. A multicolor thermosensitive recording medium according to claim 1, further comprising a third thermosensitive coloring layer developing a third hue different from the first and second hues and having a third width wherein the third thermosensitive coloring layer is continuously formed in parallel to the first and second thermosensitive coloring layers in the longitudinal direction of the substrate.

6. A multicolor thermosensitive recording medium according to claim 5, wherein the first hue is red and the second hue is black.

7. A multicolor thermosensitive recording medium according to claim 6, wherein the third hue is blue.

8. A multicolor thermosensitive recording medium according to claim 6, wherein the first width is wider than the second width.

9. A method of manufacturing a multicolor thermosensitive recording medium developing a plurality of hues, comprising the steps of:
preparing a thermosensitive recording medium main body, rolled in a longitudinal direction, on which a first, second and third thermosensitive coloring layers are formed in the longitudinal direction so as to arrange the second thermosensitive coloring layer between the first and third thermosensitive coloring layers, the second thermosensitive coloring layer developing a first hue and the first and third thermosensitive coloring layers developing respective hues different from the first hue; and
splitting the second thermosensitive coloring layer along with the longitudinal direction into a first and second recording mediums so that the first recording medium has first and second thermosensitive coloring layers and the second recording medium has second and third thermosensitive coloring layers.

10. A method of manufacturing a multicolor thermosensitive recording medium according to claim 9, wherein the first and third thermosensitive coloring layers develop a same hue.

11. A method of manufacturing a multicolor thermosensitive recording medium according to claim 9, wherein the thermosensitive recording medium main body includes a substrate made of a continuous paper weighing 90 g/m².

12. A method of manufacturing a multicolor thermosensitive recording medium according to claim 9, wherein the second thermosensitive coloring layer is split along a center thereof.

13. A method of manufacturing a multicolor thermosensitive recording medium developing a plurality of different hues, comprising the steps of:
preparing a substrate rolled in a longitudinal direction;
preparing a plurality of printing plates corresponding to the plurality of different hues;
forming on the substrate a plurality of thermosensitive coloring layers by a printing process using the corresponding printing plates to provide a multicolor thermosensitive recording medium main body on which the plurality of thermosensitive coloring layers are arranged in parallel to one another in the longitudinal direction and neighboring thermosensitive coloring layers each has different hue; and
splitting one of the plurality of thermosensitive coloring layers in the longitudinal direction into at least two thermosensitive recording mediums each developing at least two different hues.

14. A method of manufacturing a multicolor thermosensitive recording medium according to claim 13, wherein the splitting step includes a selecting step which selects one of the plurality of thermosensitive coloring layers to be split so that hue arrangement orders from the selected thermosensitive coloring layer in a direction orthogonal to the longitudinal direction are the same in adjacent thermosensitive recording mediums to be separated.

15. A method of manufacturing a multicolor thermosensitive recording medium according to claim 14, wherein the setected thermosensitive coloring layer is split along with a center thereof.

16. A method of manufacturing a multicolor thermosensitive recording medium according to claim 13, wherein the plurality of thermosensitive coloring layers are a first and second thermosensitive coloring layers partially overlapped on the substrate in a direction orthogonal to the longitudinal direction.

17. A method of manufacturing a multicolor thermosensitive recording medium according to claim 13, wherein one of the plurality of thermosensitive coloring layers is formed prior to the formation of other thermosensitive coloring layers when the one of the plurality of thermosensitive coloring layers develops a lighter hue than the other thermosensitive coloring layers.
